(19) United States
(12) Patent Application Publication
(10) Pub. No.: US 2011/0125522 A1
(43) Pub. Date: May 26, 2011

(54) PHYSICIAN ACCREDITATION SYSTEM WITH MECHANISM FOR AUTOMATED RECORDS EXTRACTION

(75) Inventors: Robert E. KAPLAN, Rockville, MD (US); James MCGURRIN, Falls Church, VA (US)

(73) Assignee: NATIONAL COMMITTEE FOR QUALITY ASSURANCE, Washington, DC (US)

(21) Appl. No.: 12/961,128

(22) Filed: Feb. 8, 2011

Related U.S. Application Data
(63) Continuation of application No. 11/644,995, filed on Dec. 26, 2006, now abandoned.
(60) Provisional application No. 60/855,136, filed on Oct. 30, 2006.

(51) Int. Cl. G06Q 50/00

(52) U.S. Cl. 705/2

(57) ABSTRACT

A system for accrediting physicians based on pre-determined best practices by examining the records for a subset of the physician's patients as measured against a set of criteria for the desired accreditation. The system provides a mechanism for automatically extracting patient records from a physician's electronic health records (EHR) system, thus minimizing the risks of data entry error and minimizing the risk of physician falsification of data. The system also provides security and privacy in order to avoid the malicious theft or accidental disclosure of patient records. The system further allows physicians to review and approve a submission before it is finally copied into the review system, allowing for correction of a submission where, for example, the wrong patient was included. The system also isolates patient data so that no user of the system has access to confidential information, apart from the physician.

### CROSS REFERENCE TO RELATED APPLICATION

The present application claims the benefit of U.S. provisional patent application Ser. No. 60/855,136, filed Oct. 30, 2006.

### BACKGROUND OF THE INVENTION

1. Field of the Invention

The present invention relates, in general, to a system of quality assurance for health care delivery including the automatic extraction of health care records. In particular, the present invention provides a system of accrediting physicians by examining health records of patients with particular conditions, where those health records are automatically extracted from the physicians' existing electronic health records systems. The health records are analyzed to produce a score for the physician that indicates the level of the physician's compliance with best practices for a particular medical specialty.

2. Relevant Background

With the exponential increase in the size of the health care industry, it is critical to be able to ensure a minimum quality of health care delivery. Although their particular concerns may be different, insurance providers, hospitals, and government agencies all have an interest in monitoring the current practices of health care providers. Insurance companies have an interest in ensuring that unnecessary procedures are not routinely performed. Hospitals and government agencies may share cost concerns, but also want to ensure that recommended procedures are being routinely performed. For a given set of symptoms presented by a patient, there are typically best practices to follow that can be verified by reviewing the actions taken by the treating health care provider. In addition, physicians are motivated to receive certifications or accreditations in those best practices, because such physicians tend to receive higher reimbursement from insurance plans.

Also, non-physicians are generally unable to evaluate the quality of potential health care providers. This is unsurprising, because most people who are not in the medical field lack a detailed understanding that might allow a determination of the skill of individual physicians, particularly in less well-known specialties and sub-specialties. Further, the detailed sub-specialization of medicine means that a more general specialty label does not give a prospective patient sufficient information to determine whether or not a physician is skilled in a needed sub-specialty. For example, a physician who is an endocrinologist by specialty might, in fact, handle almost exclusively patients with diabetes, but might have no more than infrequent experience with diseases of the pituitary gland. Typical physician listings are not able to communicate this information to patients searching for a physician.

As a result, there have been attempts to accredit or certify physicians in sub-specialties. The simplest method is to allow physicians to self-specify sub-specialties in which they practice. This method has the obvious disadvantage of a lack of quality control. Another method is to certify physicians based on continuing medical education coursework. This method ensures at least some minimum level of knowledge, but still suffers from a lack of quality control, because the physician is not monitored to ensure that she actually follows best practices in her certified sub-specialty.

A more rigorous method is to use health care providers' own health records to evaluate them. For each sub-specialty, a set of best practices is developed, wherein certain procedures are followed based on how a patient presents. The health care provider would submit records for her patients, which include symptoms, diagnoses, and procedures ordered for each patient. The records are input into a review system that automatically determines how closely the physician followed best practices for that set of patients. This automatic scoring is typically reviewed manually by an auditor to ensure accuracy. As a result, it is possible to effectively score health care providers as to how well they are following recognized best practices.

The disadvantage of this approach is the collection of health care records. Paper records must be manually entered into the system. This involves a risk of data entry errors, which typically accumulate over a large volume of data. In addition, the sheer volume of the records creates a large cost and inconvenience in handling. Often the records would need to be transported to another site for data entry, which is not inexpensive. Also, the manual handling of such a large quantity of paper records involves a substantial risk of lost or damaged paper records, as well as the potential exposure of private medical data when paper copies are removed from the health care provider's location. There is even potential legal exposure for a health care provider if a patient's records are lost or damaged. These cumulative problems create a large disincentive for physicians and other health care providers using paper records to participate. There is also a risk of a physician falsifying data, making the accreditation less reliable.

The adoption of electronic storage of health care records by itself only reduced the problems slightly. Early on, there were a plethora of diverse systems, using storage methods that did not allow for export of data or customized reports, and so the records still had to be entered manually. As data storage became more sophisticated with the widespread use of relational databases it became easier to produce reports that were easier to enter manually, but manual data entry was still required. There was still a substantial disincentive for health care providers to participate, because of the amount of work involved in producing health care records.

With the explosive growth of the Internet and broadband network availability, more and more health care providers have the potential to share data. However, although the variety of data formats has stabilized to a smaller number, there are still a number of disparate health records storage formats. Recent innovations in data transforms using languages like XML have eased the cost of sharing data.

There are also major privacy and security concerns involved with the potential sending of health care information over public networks. Unencrypted data would reveal private patient information, potentially exposing a patient to risks of identity theft or severe consequences from release of personal information. Encryption methods now exist that are secure enough for the transmission of private data. However, there remain potential security problems with the connection to a public network.

First, even though the data may be encrypted when it is transmitted, it is frequently not encrypted in local storage. A connection to the Internet potentially opens the door to hackers to break into a health records storage. One strong advantage of isolated systems is that they are unhackable from the outside, because they are not connected to any outside network. Connecting to the Internet offers enormous power of data-sharing but also enormous risk, especially where such important data is involved. One approach might be to copy data to a portable storage medium, such as a portable hard drive or a digital versatile disc (DVD). This approach has proven problematic, as has been seen in the large number of recent incidents involving lost laptops and hard drives containing personal information.

Another approach has been to use firewalls, both singly and in multiple firewall configurations to prevent access to internal systems from outside a local network except for very controlled exceptions. A computer on the Internet has an Internet Protocol (IP) address, consisting of four bytes, usually represented as four 1-byte numbers separated by periods, as in 192.168.0.1. In order to allow applications to speak to each other, the Transport Control Protocol (TCP) layer assigns a 16-bit number called a port to each application. A firewall is a program that monitors all traffic at the TCP layer and blocks communications on all ports except those that are designated as open. Often a firewall uses port address translation (PAT) to translate incoming port numbers to different internal port numbers, preventing a straight pass-through on any port. Some networks use two firewalls, with servers in between. The “outer” firewall is open on different ports from the “inner” firewall, so that it is not possible to tunnel straight through a single port to an internal machine. Servers in between the two are in the “DMZ” and relay traffic between outside and inside the firewalls. This setup is called a screened-subnet firewall. Applications that allow use through a screened-subnet firewall are potentially extremely secure.

Properly maintained and configured firewalls provide protection from malicious Internet traffic. However, once data leaves an internal network, it is potentially visible to anyone on the Internet who is monitoring traffic. As a result, various encryption schemes are used to encrypt data before sending it. The most common encryption methods are some variant of public-key cryptography. Public-key cryptography uses two keys, one publicly known and one private, stored as a pair. The public key can be used to encrypt data that is sent to the possessor of the private key, who is the only one able to decrypt the message. Public key systems rely on the difficulty of inverting the solution to certain problems, like factoring large numbers, for their security. One vulnerability of public key systems is ensuring that the public key is the correct one for the desired receiver. A common solution to this has been to use an authority that certifies a public key as belonging to a known receiver. The secure sockets layer (SSL) protocol is a commonly used protocol that uses this method. For example, SSL is typically used to encrypt credit card details. Although these encryption methods are not perfect, they do provide significant protection for sensitive data.

Assuming that data can be securely and privately sent across the Internet, there still may be compatibility problems. Two different applications typically store data in different formats, even if the applications serve the same functions. For example, they may name their underlying data fields differently, and may use overlapping but different sets of fields. Or, the applications may execute on different computing platforms which store numbers differently. If only two applications need to communicate, often it is practical to implement a module for each application that directly translates to the format of the other. Where the goal is to collect data from a number of different sources with different data formats, such a solution quickly becomes unmanageable because of the quadratic growth in the number of required modules. The best approach is to develop a single intermediate format and provide modules for translating between each application and the intermediate format.

One method is to create a new data record format and build independent converters. Depending on the chosen format, such converters can be easy or difficult to implement. In the mid-1990's, a flexible markup language was developed called the Extensible Markup Language (XML). Although its original goal was to simplify publishing on the Internet, people soon realized that XML could be used to define data formats and allow for the efficient interchange of data between applications. The main advantages to XML for data exchange are that it uses text, which can be produced by almost any program, and it is standardized, meaning that a number of tools are available that can parse XML files, reducing development time. There have also been additions to XML allowing the design of schemas (i.e., data dictionaries) that can impose a validatable structure on an XML document, and tools also exist to take a given schema and validate an XML document with respect to that schema.

### SUMMARY OF THE INVENTION

The present invention describes a system for accrediting physicians based on pre-determined best practices. A physician is evaluated according to how well she has been following best practices. This is determined by examining the records for a subset of the physician's patients. The records are measured against a set of criteria for the desired accreditation.

The system provides a mechanism for automatically extracting patient records from a physician's electronic health records (EHR) system, thus minimizing the risks of data entry error and minimizing the risk of physician falsification of data. The system also provides security and privacy in order to avoid the malicious theft or accidental disclosure of patient records. The system further allows physicians to review and approve a submission before it is finally copied into the review system, allowing for correction of a submission where, for example, the wrong patient was included. The system also isolates patient data so that no user of the system has access to confidential information, apart from the physician.

### BRIEF DESCRIPTION OF THE DRAWINGS

FIG. 1 illustrates an overview of the technical components of an embodiment of the invention;

FIG. 2 illustrates an overview of a method of sending, receiving, and approving health records for physician accreditation; and

FIGS. 3A and 3B illustrate methods of sending and receiving health records.

### DETAILED DESCRIPTION OF EMBODIMENTS

The present invention is a system for physician accreditation, improved by a mechanism for extracting records automatically from electronic health records (EHR) systems. The system rates physicians according to how well they manage patients with particular conditions, such as diabetes or cardiovascular disease. For a given type of accreditation, e.g., diabetes treatment, a set of criteria are created to score a physician's treatment of patients with that condition. The physician submits data for a selected set of patients, including their latest test results, blood pressure, and other physical parameters as well as procedures, medications, and advice that have been given. For example, patients who are at risk for heart attack or stroke should ideally have a blood pressure below 140/90 mm of mercury (Hg). A physician for whom 75% of such patients have that recommended blood pressure would score higher than one for whom 75% have a slightly higher blood pressure but could not meet the recommended range. Points are awarded based on a threshold number of patients out of the sample having the desired test measurement or receiving the desired treatment.

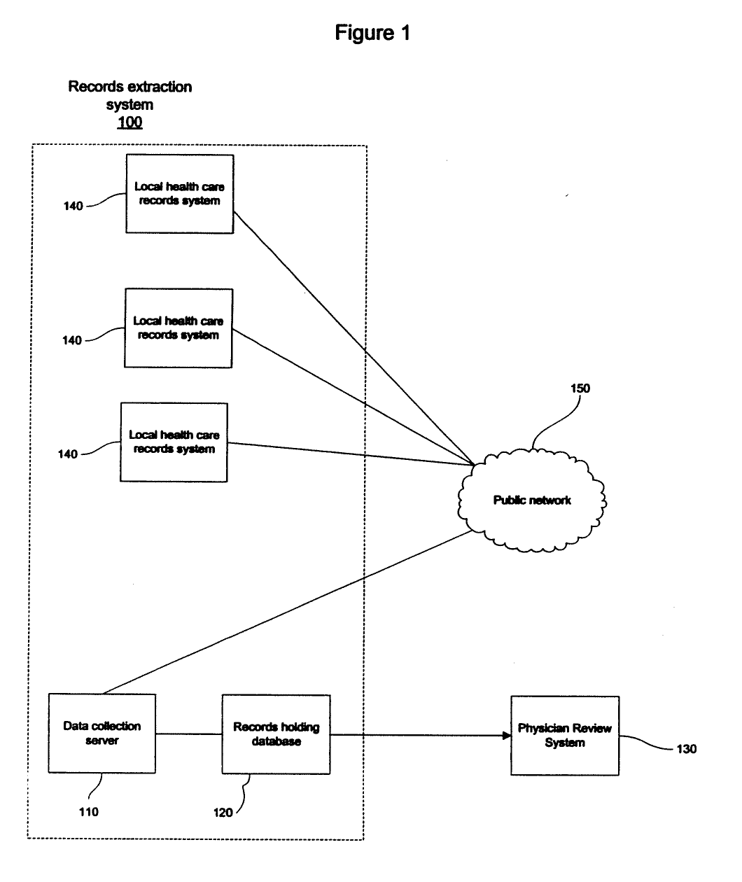

FIG. 1 illustrates an overview of an embodiment of the present invention. The records extraction system 100 delivers health care records to the physician review system 130. The physician review system 130 analyzes the health care records as explained above in order to score a physician's compliance with best practices. The records extraction system 100 includes a data collection server 110, a records holding database 120, and a plurality of physicians' local health records systems 140. A local health records system 140 communicates with the data collection server 110 over a public network 150, such as the Internet. Records are collected at the local health records system 140 and sent to the data collection server 110. The data collection server stores those records in the holding database 120, and only releases the records to the physician review system 130 after the physician approves the release.

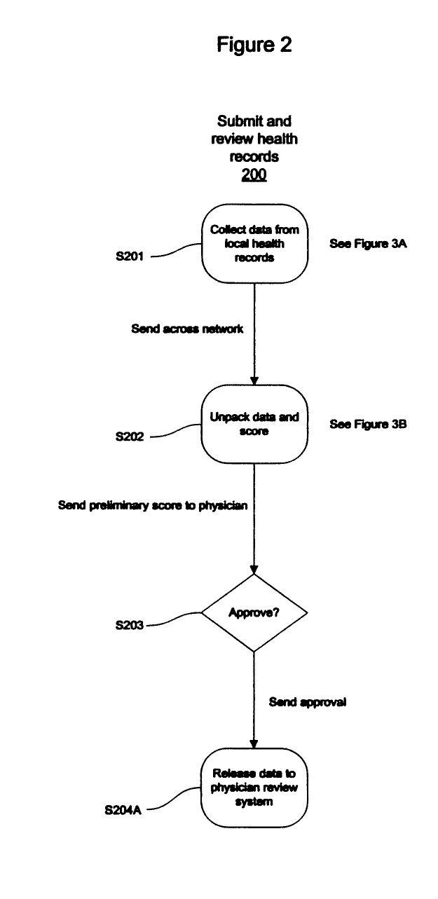

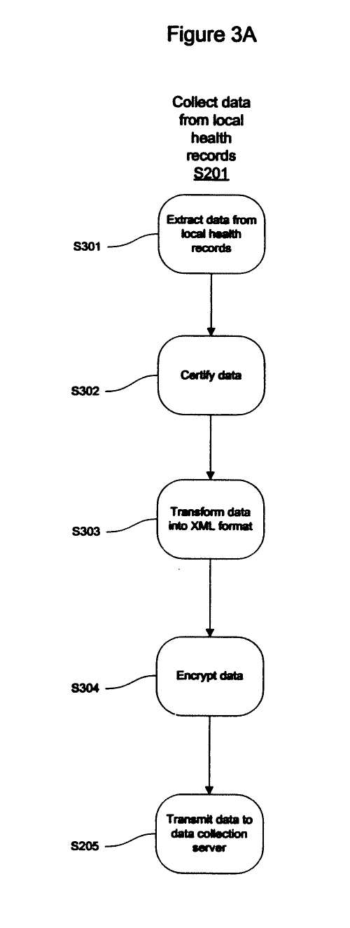

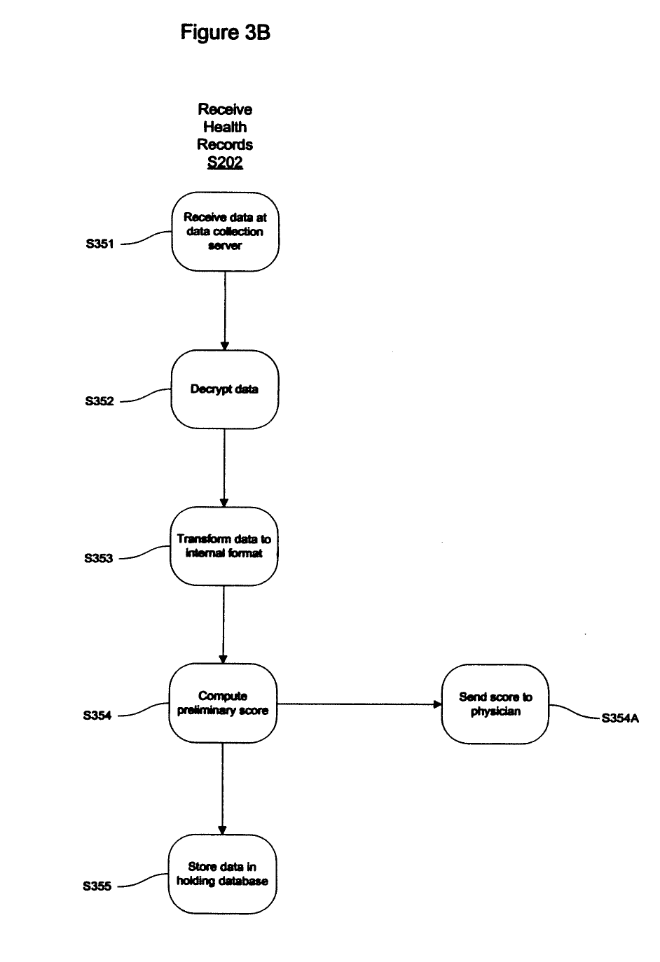

FIG. 2 illustrates a method of using the records extraction system 100. In step S201, data is collected at the local health records system 140. This step is illustrated in more detail in FIG. 3A and explained below. This data is sent across the public network 150 to the data collection server 110. In step S202, illustrated in more detail in FIG. 3B and explained below, the data collection server receives the health care data, unpacks it, stores it in the records holding database 120, and computes a preliminary score. The preliminary score is sent back to the physician. In step S203, the physician approves the submission using the local health records system 140, or takes no action. If the physician sends approval back to the data collection server, step S204A is performed, which releases the data to the physician review system 130. If the physician does not send approval, the data in the holding database 120 will eventually expire and be purged. One embodiment purges data after 30 days.

FIG. 3A illustrates the data collection step S201 in more detail. In sub-step S301, data is collected from the local health records system 140. Physicians voluntarily select a sample set of patients. Eligibility for a patient to be included is determined by criteria such as length of time since diagnosis, length of time under the physician's care, and age. The records for those patients are exported from the physician's EHR system, with identifying information removed. One embodiment of the present invention exports the records into an intermediate file using the export feature of the EHR system. Another embodiment uses an application loaded onto the physician's computer system to query the EHR system for the selected records and extract the data from the system. For Structured Query Language (SQL) based EHR systems, data is extracted from the EHR system via a SQL query to the underlying database. For XML-based EHR systems and systems that support XML-based queries, data is extracted using a standard XML query language such as XPath or XQuery.

The basic data entities are practices, physicians, and charts. A practice is a group of physicians. A physician submits a set of charts. The charts contain the data fields that will be analyzed in computing the physician's eventual score, as explained above. Thus, the data is nicely hierarchical. This structure, which is maintained throughout, allows a practice to submit charts for all or some of its physicians at once.

In sub-step S302, the extracted data is then certified to ensure that it is complete and that all selected patients are eligible for inclusion in the sample. The system first uses a data dictionary to validate data types, ranges, enumerations and other validity information. One embodiment uses XML and an XML Schema file to validate the data. Another embodiment uses a scripting language such as Perl to validate the data. Another embodiment uses a database-enabled application written in a programming language, such as Java or C++, to validate the data. In all cases, the actual data dictionary is stored in a file and read in, so that type definitions and other constraints can be changed without modifying programming code. The certification process then performs additional tests to ensure internal consistency of data, such as dates being in a sensible order relative to each other, test values being consistent with a live patient (e.g., blood pressure data greater than 0), and other tests specific to the nature of the data elements (e.g., foot exams not being indicated for diabetic patients who have had foot amputation).

In sub-step S303, the certified data is then translated into an intermediate format. One embodiment uses XML and an XML Schema for the intermediate data format. Another embodiment stores the data in an internal data structure that is then transmitted using a distributed object or remote procedure call protocol such as CORBA. The translation is performed by an application running on the physician's computer. In one embodiment, this application runs through a web page, such as a Java® applet or an ActiveX® control. In another embodiment, this application is standalone, and can be downloaded and installed or installed from a storage medium like a CD-ROM or DVD. The translated data file is then encrypted and transmitted across the Internet to a known and trusted data collection server.

One embodiment uses XML and the Simple Object Access Protocol (SOAP) to transmit the data to the data collection server. The data is extracted to an external XML formatted file, matching the published schema that is stored in the EHR file system, or extracted directly to a data stream connected via the Internet using HTTP, SOAP, FTP, and REST based protocols. The data collection server provides Web Service based data receipt, parsing and storage services. Other embodiments use a different distributed data exchange protocol, such as CORBA, Enterprise Java Beans, or DCOM. Some embodiments support multiple protocols at the data collection server in order to allow for more flexible implementation at the physician's computer system. For example, while CORBA is more efficient at transmitting large quantities of data, not all networks allow it to pass through their firewalls because it is binary data. SOAP uses the transmission of text, which is generally allowed through firewalls, although the size of the data is correspondingly larger.

As explained above, one embodiment uses XML to send the collected data. XML is a markup language. A markup language is a computer language that allows the markup of text with tags that indicate how a piece of text should be displayed or interpreted. For example, Hypertext Markup Language (HTML) is used to markup text so that it can be displayed as a web page through a browser like Firefox® or Internet Explorer®. As a simple illustration, in HTML, the text “<b>United States</b>” indicates to a browser that “United States” should be displayed in bold. The primary advantage to using a markup language to send data is that text is generally allowed to pass through firewalls. Using a more generic markup language like XML has the added advantage that the data structure can be customized more easily for certain purposes, without having to rewrite the underlying programming code. Further, because XML is text, it is relatively easy to generate.

XML provides a way to overlay an interpretive structure onto a document (i.e., text) using user-defined tags. As a result, this user-defined structure can be used for more than just documents that one might display on a screen. It can also be used to define any set of data by delineating fields, records, and other data boundaries with tags. XML's natural recursive structure makes it easy to wrap data from a database table, and such techniques are well-known. Because it is also possible to create a data dictionary for XML, it is possible to ensure that an XML document complies with a given set of rules, which provides the necessary data validation enabling data exchange between different applications. A standard method for defining a data dictionary for XML is to use the XML Schema specification. Another advantage to XML is that tools exist that allow the easy transformation of an XML document into another XML document, a text document in a different format, or even a data stream. Examples of such tools include XSLT and XQuery.

Returning to the discussion of FIG. 3A, the translated data is created in sub-step S303, as explained above. In sub-step S304, the translated data is encrypted. In one embodiment, this encryption is public-key encryption performed in accordance with the SSL specification. In sub-step S305, the encrypted data is transmitted to the data collection server 110. If SSL is used, this transmission will be in accordance with the standard. If another encryption method is used, data may be transmitted using a different method. For example, encrypted data could be transmitted over TCP to a pre-designated port on the data collection server 110.

FIG. 3B illustrates step S202 from FIG. 2 in more detail. As explained above, the system includes a secure data collection server 110 for receiving data from a physician's EHR system. One embodiment of the data collection server 110 listens on the SSL port for data, as a web service. Another embodiment of the data collection server 110 uses a custom port number and a standard handshake protocol to set up a connection with the computer at the physician's location. Once the encrypted data arrives, it must be decrypted, unpacked, and processed, as described below. One embodiment of the data collection server 110 performs these steps. Another embodiment of the data collection server stores the incoming data on an internal server (not shown in FIG. 1), for example, inside an internal firewall, but does none of the processing.

In sub-step S351, the data arrives at the data collection server 110. In sub-step S352, the incoming data is decrypted in accordance with the encryption method used in sub-step S304 as explained above with respect to FIG. 3A. In sub-step S353, the decrypted data is unpacked and translated to an internal relational database format using an extract/load algorithm. The extract/load algorithm extracts the hierarchically structured data from the data file and loads it into a SQL database. The algorithm maintains the relationships between physicians and practices, as well as charts and physicians.

One embodiment of the extract/load algorithm utilizes the features of XML parser toolkits to “walk” thru the hierarchically structured XML data, referencing elements in context. That is, when a “chart” is extracted, the context for that chart (i.e., the physician and the physician's practice) is kept in memory. Other embodiments similarly maintain context when extracting data. An external mapping is used to map data fields in the incoming data to data fields in the internal storage database. One embodiment uses meta data kept in supporting tables in a relational database to automatically relate an XML element's data to a set of records to store in internal relational database tables. One embodiment uses three internal tables, one for practices, one for physicians, and one for charts. Thus, when the element for a practice is processed, the meta data indicates that a new practice record is created, and the primary key of that record is kept in context. Some attributes or elements of the practice will be mapped to fields of the practice record according to the meta-data. Physicians and charts are processed similarly. Other internal table structures are possible, although only the meta data needs to be changed in order to accommodate a different structure. That is, support for revisions to the data dictionary for the charts data or the data dictionary for the internal tables is provided without programming, but instead via entries in the meta-data tables. Similar meta data are used to drive the subsequent computation of aggregate data, such as overall scores for patients receiving treatment consistent with the developed “measures” for specific diseases.

Some embodiments use a physician approval procedure before submitting the data to the review process. In the approval procedure, a preliminary score is computed for the physician in sub-step S354 and sent to the physician in sub-step S354A. The preliminary score is computed using generic algorithms that interpret meta data descriptions of the quality assurance measures being assessed for particular disease/diagnosis treatment. The generic algorithms require meta data describing what chart data elements have particular values or ranges of values in order to be considered “eligible” (e.g., a patient is eligible to be considered for assessment of Diabetes treatment quality if the patient is currently receiving insulin). Similarly, the generic algorithms require meta describing what chart data elements have particular values that demonstrate “good” care (e.g., patient has lipid assessments and counseling for correcting any unhealthy readings). The data is stored in a temporary holding database in sub-step S355.

As explained above in the discussion of FIG. 2, when the physician is satisfied, she submits the data (e.g., presses a button or selects a menu item indicating submission) for review. The data is then released from the temporary holding database to the physician review system 130, where it is analyzed automatically as explained above. The physician may not be immediately available to perform the approval process, so data is held in the holding database for a set period of time before expiring. Once the data expires, the physician will need to start the process over.

We claim:

1. A distributed computer system for accrediting a health care provider comprising:
a first database comprising health records associated with said health care provider;
a records extraction system connected to the first database, the records extraction system comprising:
an extraction module configured to copy selected health records, translate the selected health records into a pre-specified XML format, store the translated health records in a single XML file, encrypt the XML file using a pre-specified encryption scheme, and transmit the encrypted XML file across a network,
a data collection server, wherein the data collection server receives the encrypted XML file, decrypts the encrypted XML file using the pre-specified encryption scheme, translates the XML file into an internal data storage format comprising health care review data records, and computes a preliminary accreditation score for the health care review data records, and
an extraction database for temporarily storing the health care review data records; and
a physician review system connected to the records extraction system for receiving and scoring the stored health care review data records from the extraction database.

2. The distributed computer system of claim 1 further comprising a review database connected to the physician review system to store the received health care review data records.

3. The distributed computer system of claim 1, wherein the records extraction system forwards the preliminary accreditation score to the health care provider.

4. The distributed computer system of claim 3, wherein the records extraction system is adapted to receive an approval signal from the health care provider, and the records extraction system does not forward stored health care review data records to the physician review system until the records extraction system receives the approval signal from the health care provider.

5. The distributed computer system of claim 1, wherein the extraction module is further configured to certify the selected health records.

6. The distributed computer system of claim 5, wherein the certifying of the selected health records by the extraction module comprises verifying that the health records conform with a desired format.

7. The distributed computer system of claim 5, wherein the certifying of the selected health records by the extraction module comprises searching the health records for pre-specified data, and rejecting health records containing said pre-specified data.

8. The distributed computer system of claim 1, wherein the extraction module operates in batch mode to collect the health records periodically.

9. The distributed computer system of claim 1, wherein the extraction module operates in real time to collect the health records when updated.

10. The distributed computer system of claim 1, wherein the healthcare provider is a first healthcare provider, and wherein the distributed computer system further comprises a second database comprising health records associated with a second health care provider, wherein the records extraction system is connected to both the first and the second databases, and wherein the physician review system receives and scores the stored health care review data records for both the first and the second health care providers.

11. A health care provider accreditation method comprising:
providing a first database comprising health records;
extracting said health records, said extracting step comprising copying selected health records, translating the selected health records into a pre-specified XML format, storing the translated health records in a single XML file, encrypting the XML file using a pre-specified encryption scheme, and transmitting the encrypted XML file across a network to a data collection server;
said data collection server decrypting the encrypted XML file using the pre-specified encryption scheme, translating the XML file into an internal data storage format comprising health care review data records, and computing a preliminary accreditation score for the health care review data records;
temporarily storing the health care review data records; and
transmitting the health care review data records to a physician review system for scoring the stored health care review data records.

12. The health care provider accreditation method of claim 11 further comprising the physician review system storing the received health care review data records.

13. The health care provider accreditation method of claim 11 further comprising the step of forwarding the preliminary accreditation score to the health care provider.

14. The health care provider accreditation method of claim 13 further comprising receiving an approval signal from the health care provider, wherein stored health care review data records are not forwarded to the physician review system until the approval signal from the health care provider is received.

15. The health care provider accreditation method of claim 11 further comprising the step of certifying the selected health records.

16. The health care provider accreditation method of claim 15, wherein the certifying of the selected health records comprises verifying that the health records conform with a desired format.

17. The health care provider accreditation method of claim 15, wherein the certifying of the selected health records comprises searching the health records for pre-specified data, and rejecting health records containing said pre-specified data.

18. The health care provider accreditation method of claim 11, wherein the health records are collected periodically.

19. The health care provider accreditation method of claim 11, wherein the health records are collected automatically when updated.

20. An automated health care provider accreditation system for acquiring and scoring stored health records associated with a health care provider; the system comprising a records extraction system connected to the first database, the records extraction system configured to copy selected health records, translate the selected health records into a pre-specified XML format, store the translated health records in a single XML file, encrypt the XML file using a pre-specified encryption scheme, and transmit the encrypted XML file across a network;
a data collection server configured to receive the encrypted XML file, wherein a data collection server decrypts the encrypted XML file using the pre-specified encryption scheme and translates the XML file into an internal data storage format comprising health care review data records; and
a physician review system configured to receive and score the stored health care review data records.
